(19) United States
(12) Patent Application Publication
(10) Pub. No.: US 2013/0153133 A1
(43) Pub. Date: Jun. 20, 2013

(54) Apparel Tattoo Method

(71) Applicant: Samantha Kane, Calabasas, CA (US)

(72) Inventor: Samantha Kane, Calabasas, CA (US)

(21) Appl. No.: 13/716,022

(22) Filed: Dec. 14, 2012

Related U.S. Application Data
(60) Provisional application No. 61/576,017, filed on Dec. 15, 2011.

(51) Int. Cl. B44C 1/18

(52) U.S. Cl. CPC B44C 1/18
USPC 156/230

(57) ABSTRACT

A convenient and simple method to apply permanent designs, artwork, messages, etc. . . . to shoes by manually by applying a tattoo having a base layer, a top layer, and an intermediate ink layer containing the design, artwork, or message to applied. The ink layer is permanently transferred to the shoe by manually applying pressure or water.

This application claims the benefit of priority to U.S. provisional patent application 61/576,017 filed on Dec. 15, 2011.

### BACKGROUND OF THE INVENTION

The present invention relates to a method for decorating non-washable shoes, apparel, and accessories with images, designs, artwork, messages, etc. . . .

### BRIEF SUMMARY OF THE INVENTION

An object of this invention is to provide a convenient and simple method for a user to manually apply designs, artwork, messages, etc. . . . to shoes, clothing, and accessories. It is common for users to want to decorate items of clothing, accessories, and shoes. A number of methods are known for doing this. For shoes such methods may include swapping shoe laces with laces in a new color, a length of textured ribbon or printed twill tape. Wrapping lace around sandal straps, gluing decorative trim to flip-flops or using ribbon and jump rings to add charms to a shoe. Other methods include, for example, adding a clip-on earring, affixing metal studs or self-adhesive rhinestones, arranging small gems around the tops or toes of shoes. It is also known to use iron-on patches and add stickers or decals to shoes. Hook and loop fasteners (a.k.a. “velcro”) may be used to semi-permanently attach decorative items to shoes, accessories or articles of clothing. The use of fabric markers and paint for decorative purposes is also known.

All of the aforementioned methods of decorating a shoe or accessory however don't give a user a convenient, easy, and quick way of manually applying permanent high quality pre-made artwork, designs, or messages to shoes, clothing or accessories. The present invention achieves this through a user applied apparel tattoo.

Tattoos as applied the skin of a person are well known in the art. Traditional tattoos are made by inserting indelible ink into the dermis layer of the skin to change the pigment. Such traditional tattoos are permanent. Not everyone is interested in a permanent tattoo, so temporary tattoos have been developed. A temporary tattoo is a non-permanent image on the skin usually resembling a permanent tattoo. Temporary tattoos can be drawn, painted, or airbrushed, as a form of body painting but most of the time these tattoos are transferred to the skin

The modern temporary transfer tattoo generally consists of the following elements: a sheet of paper with a front side and a back side, an adhesive, ink and a removable protective sheet. It comes in two general forms: One which is applied through the use of water, and the other which is a dry transfer or waterless tattoo. Temporary tattoos that are applied with water to the skin use an adhesive waterslide material on a paper substrate. The adhesive waterslide material is typically comprised of dextrose. Such a tattoo will transfer the ink image to skin when water has fully penetrated the paper backing to release the waterslide material which transfers to the skin surface along with the ink image. The adhesive waterslide material when dry will temporarily bond the ink image to the skin surface. A typical waterslide tattoo is applied by the user by pressing the tattoo against the skin and applying water to it, usually with a sponge, until it is well soaked. The backing is then removed with the ink image adhering to the skin surface.

The dry transfer tattoo does not require the application of water, and has grown in popularity due to sanitary concerns with waterslide tattoos. Specifically, children who are a primary user of temporary tattoos frequently use saliva rather than water to apply the waterslide tattoos. A waterless tattoo usually comprises a base layer, such as for example paper. The base layer has a transfer coating applied to a front surface, and an ink image is applied to the transfer coating. A pressure sensitive adhesive layer is applied on top of the ink layer, followed by a removable protective layer applied on top of the adhesive layer. A user applies the dry transfer tattoo by removing the protective top layer and applying the pressure sensitive adhesive layer to the skin surface, such that the base layer faces away from the skin surface. The user then applies pressure to the base layer for a period of time. The pressure causes the adhesive layer to bond with the skin surface and also bonds the ink image to the adhesive. The user then removes the base layer with the adhesive layer bonding the ink image to the skin surface.

While the use of temporary tattoos such as described above (and in greater detail herein) is well known for applying images to human skin surfaces, it has not been previously used to apply images, artwork, designs, or messages to the surfaces of non-washable shoes, apparel or accessories. It is the object of the present invention to apply such temporary skin tattoo technology towards a new use on the surfaces of non-washable shoes, apparel and accessories. It should be noted that while such temporary skin tattoo technology is temporary when applied to human skin (which is washed, and where the outer skin cells are shed over time) its effect is of a more permanent nature when applied to articles of non-washable shoes, apparel and accessory items (e.g. purses, bags, etc. . . . ). Thus, the use of such “temporary” tattoo technology can achieve a convenient, affordable, and easy way for a user to manually apply permanent high quality pre-made artwork, designs, or messages to non-washable shoes, clothing or accessories.

### BRIEF DESCRIPTION OF THE SEVERAL VIEWS OF THE DRAWINGS

FIG. 1 is a schematic illustrating a cross-section of a dry transfer tattoo as used in the present apparel tattoo method.

FIG. 2 is a flow chart of a method for applying an image to an article of manufacture such as apparel, shoes, or accessories using a dry transfer tattoo.

FIG. 3 is a schematic illustrating a cross-section of a waterslide tattoo as used in the present apparel tattoo method.

FIG. 4 is a flow chart of a method for applying an image to an article of manufacture such as apparel, shoes, or accessories using a waterslide tattoo.

### DETAILED DESCRIPTION OF THE INVENTION

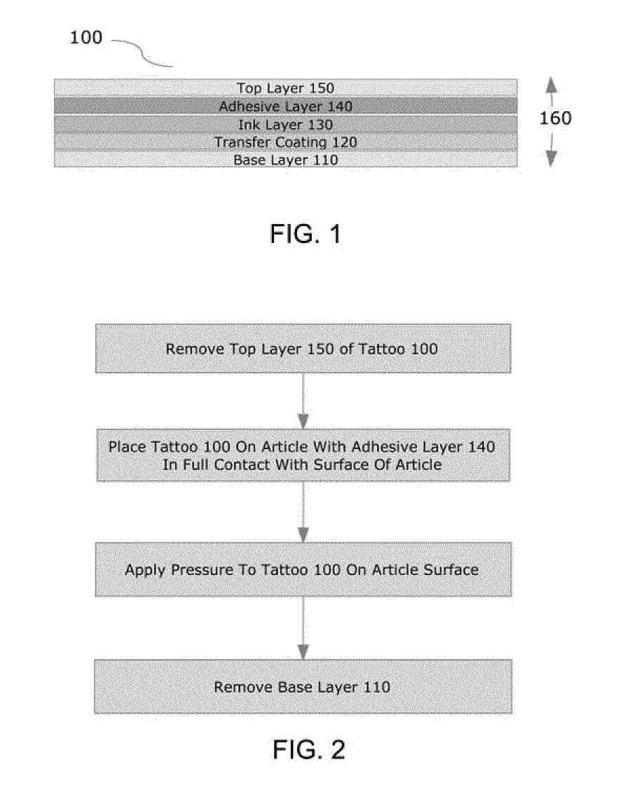

In a first preferred embodiment of the present invention a dry transfer tattoo is used to manually apply a permanent image, design, artwork, message, etc. . . . to non-washable shoes, apparel and accessories. Referring to FIG. 1, a tattoo 100 according to one embodiment of the present invention is comprised of a base layer 110; a transfer coating 120; an ink layer 130; an adhesive layer 140; and a top layer 150. The base layer 110 and the top layer 150 may be made of plastic film or of paper. The base layer 110 and the top layer 150 may also be different materials. For example, the base layer 110 may be paper and the top layer 150 may be plastic film. The material composition of layers 110, 120, 130, and 140 as well as the cumulative thickness 160 of tattoo 100 should be such that tattoo 100 with top layer 150 removed is thin and flexible enough so that it may be readily bent and be applied with full surface contact of adhesive layer 140 across a curved or contoured surface of the article that the ink image is intended to be applied to (e.g. the heel of a shoe).

The transfer coating 120 is releasably adhered to base layer 110 and enables base layer 110 to be peeled off once adhesive layer 140 is applied to an apparel surface. Transfer coating 120 allows ink layer 130 to be deposited on either paper or plastic film substrates by providing a treated surface that helps with ink integrity and ink adhesion. Transfer coating 120 does not permanently bond to base layer 110, and allows ink layer 130 to be transferred to adhesive layer 140. The transfer coating may be comprised of a non-stick silicone release coating applied to base layer 110, with an overlaying transfer film on top of the silicone layer. The overlaying transfer film is the surface that ink layer 130 is deposited on and may be composed of gelatin or other polymeric materials such as polyvinyl alcohol or polyvinyl pyrollidone. These materials are designed to be strong enough to adhere to the backing paper during printing yet flexible enough to be easily released during application.

The ink layer 130 is deposited on transfer coating 120 Ink layer 130 may comprise, for example and without limitation, artwork, a design, a picture, a symbol, text, a message, a logo, etc. . . . Ink layer 130 may be made up of multiple layers of different colors of ink to produce an image with multiple colors. Ink layer 130 may be comprised of, but is not limited to, flexography ink (either water based or solvent based), silk screen ink, offset ink or gravure ink

Adhesive layer 140 is deposited on the ink layer 130. Adhesive layer 140 may be a pressure sensitive adhesive, such as for example, an aqueous flexographic pressure sensitive adhesive. Acrylic and polyurethane compositions may also be used. The particular adhesive composition may be varied for particular material surfaces that it is contemplated the tattoo may be applied to. For example, there could be a particular formulation of adhesive that is best suited to bonding with plastics, another for leather, and perhaps another for cloth.

Top layer 150 is releasably applied to the adhesive layer 140. Top layer 150 may preferably be a silicone coated substrate, where the substrate may be a plastic film or paper. In this way top layer 150 is removable from adhesive layer 140.

The dry transfer tattoo 100 may be easily used to manually apply the image printed on it to a non-washable article of manufacture. FIG. 2 is a flowchart of a method of applying a dry transfer tattoo made.

The first step of FIG. 2 is to remove top layer 150 of tattoo 100. This exposes adhesive layer 140. The next step is to locate tattoo 100 over a position on the surface of the article of apparel, shoes, or accessories (hereinafter the “article”) where the tattoo image is desired to be placed. Tattoo 100 is then placed on the surface of the article with adhesive 140 on the article surface. The surface of the article where the tattoo is placed should be clean and dry. The next step is to apply pressure to tattoo 100. The application of pressure may be done manually with a hand or finger. Alternatively it may be done with the aid of a tool (e.g. a blunt end of stylus, pen, etc. . . . ). Pressure may preferably be applied continuously and uniformly across the tattoo surface, although a rubbing motion against the tattoo surface may also be used in appropriate circumstances. In a preferred embodiment of the method pressure is maintained on tattoo 100 for at least 1 minute. The application of pressure causes pressure sensitive adhesive to bond with the article surface, and also ink layer 130. In the next step the user manually removes base layer 110 by peeling it away from the article surface. Transfer coating 120 allows base layer 110 to be separated from adhesive layer 140 and ink layer 130 which is now bonded to adhesive layer 140, and is thereby bonded to the article surface.

In some embodiments transfer coating 140 may also adhere to adhesive layer 140 and remain on the article surface overlaying ink layer 130. In other embodiments transfer coating 140 may remain bonded to base layer 110 and separate from ink layer 130 and adhesive layer 140.

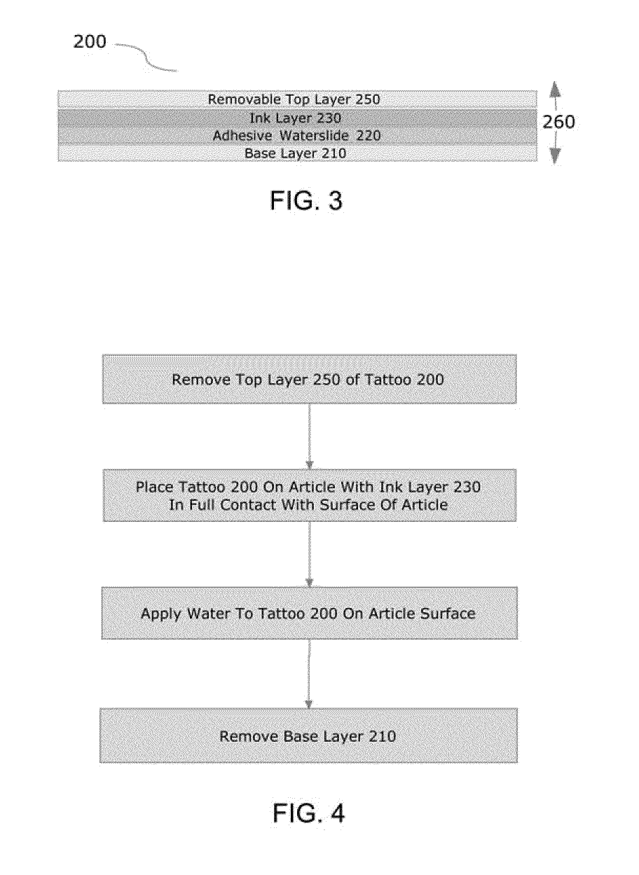

The use of a dry transfer tattoo is well suited for application to a wide variety of articles of apparel, shoes, and accessories. Waterslide tattoos may also be used to apply images, designs, artwork, or text to articles that can be wetted with water and not be damaged. A general configuration of a waterslide tattoo 200 is shown in FIG. 3. As with tattoo 100, the material composition of layers 210, 220, and 230 as well as the cumulative thickness 260 of tattoo 200 should be such that tattoo 200 with top layer 250 removed is thin and flexible enough so that it may be readily bent and be applied with full surface contact of ink layer 230 across a curved or contoured surface of the article that the ink image is intended to be applied to (e.g. the heel of a waterproof shoe).

The method of applying a waterslide tattoo 200 is illustrated in FIG. 4. The first step is to remove top layer 250 of tattoo 200. This exposes ink layer 230. The next step is to locate tattoo 200 over a position on the surface of the article of apparel, shoes, or accessories (“article”) where the tattoo image is desired to be placed. Tattoo 200 is then placed on the surface of the article with ink layer 230 on the article surface. The surface of the article where the tattoo is placed should be clean and dry. The next step is to apply water to the outward facing surface of base layer 210 while firmly pressing tattoo 200 on the article surface. The application of water and pressure may be done manually, for example, with a wet sponge. Pressure may preferably be applied continuously and uniformly across the tattoo surface, although a rubbing motion against the tattoo surface may also be used in appropriate circumstances. Once tattoo 200 is thoroughly soaked with water the pressure should be maintained across tattoo 200 for preferably 2-3 minutes. The application of water and pressure causes waterslide material 220 to release from base layer 210 and adhere to the article surface, transferring ink layer 230 to the article surface. In the next step the user manually removes base layer 210 by peeling or sliding it away from the article surface, leaving ink layer 230 and waterslide material 220 on the article surface. After at least several minutes the water will evaporate from the article surface leaving behind the image of ink layer 230 and dried waterslide material 220.

1. A new method for manually applying a permanent ornamental design to a shoe comprising the steps of:
forming an ornamental design in an ink layer that is sandwiched between a base layer, a transfer coating, an adhesive layer, and a top layer;
manually removing said top layer;
manually placing said adhesive layer on a surface of said shoe such that said base layer faces outward;
manually applying pressure across said base layer; and
manually removing said base layer.

2. The method of claim 1 wherein said base layer and said top layer are comprised of plastic;

3. The method of claim 1 wherein said base layer and said top layer are comprised of paper;

4. The method of claim 1 wherein said transfer coating is a polymeric material;

5. The method of claim 1 wherein said adhesive layer is an aqueous flexographic pressure sensitive adhesive;

6. A new method for manually applying a permanent ornamental design to a shoe comprising the steps of:
forming an ornamental design in an ink layer that is sandwiched between a base layer, an adhesive waterslide layer, and a top layer;
manually removing said top layer;
manually placing said ink layer on a surface of said shoe such that said base layer faces outward;
manually applying water across said base layer; and
manually removing said base layer.

7. The method of claim 7 wherein said base layer and said top layer are comprised of plastic;

8. The method of claim 7 wherein said base layer and said top layer are comprised of paper;

9. The method of claim 7 wherein said adhesive waterslide layer is comprised of dextrose;
